(19) United States
(12) Patent Application Publication
(10) Pub. No.: US 2025/0148478 A1
(43) Pub. Date: May 8, 2025

(54) COMPUTER-IMPLEMENTED METHOD OF PROPOSING A COACH TO A COACHEE

(71) Applicant: CoachHub GmbH, Berlin (DE)

(72) Inventor: Pedro Cabrera, Berlin (DE)

(73) Assignee: CoachHub GmbH, Berlin (DE)

(21) Appl. No.: 18/837,981

(22) PCT Filed: Feb. 14, 2022
(86) PCT No.: PCT/EP2022/053536

§ 371 Date: Aug. 13, 2024

(51) Int. Cl. G06Q 30/015; G06Q 10/0639; G06Q 30/0282

(52) U.S. Cl. CPC G06Q 30/015; G06Q 10/06398; G06Q 30/0282

(57) ABSTRACT

A computer-implemented method proposes a coach fitting well to a coachee. The method includes maintaining a pool of coaches, each coach possessing established properties, prompting the coachee to make a selection of preferences with respect to the coach, such as a preferred mother tongue, education, training, certifications, experience, industry focus, or gender of the coach, and based upon the properties, matching, according to the selection, the coachee with the coaches from the pool. If one among the coaches fits the coachee, a profile of the fitting coach is presented to the coachee by means of an application such as a web or smartphone app.

### TECHNICAL FIELD

The invention relates to the process and products as per the first portion of the independent claims.

### BACKGROUND ART

Coaching is a form of development in which an experienced person, called a coach, supports a learner or client—hereinafter referred to as the coachee—in achieving a specific personal or professional goal by providing training and guidance. More specifically, business coaching—sometimes labelled executive coaching, corporate coaching, or leadership coaching—is a type of human resource development for executives, members of management, teams, and leadership. Here, the coach provides positive support, feedback, and advice to improve the coachee's personal effectiveness in the business setting and help him or her advance towards specific professional goals pertaining to, for instance, career transition, interpersonal and professional communication, performance management, organizational effectiveness, developing executive presence, enhancing strategic thinking, dealing effectively with conflict, and building an effective team within an organization.

By way of example, PTL1 discloses an interactive performance training and coaching system that focuses on both knowledge acquisition and behavioral embedding of skills and techniques such as through Web-based seminars.

### SUMMARY OF INVENTION

The invention is set out in the appended set of claims.

### TECHNICAL PROBLEM

According to NPL1, 75% of all employees consider the training offered to them as ineffective. Often this is due to the “seminar effect”—employees may leave a seminar feeling well-informed and motivated, but the positive effects decrease as employees find themselves back carrying out their day-to-day routines.

### SOLUTION TO PROBLEM

The problem is solved as per the second portion of claim 1.

### ADVANTAGEOUS EFFECT OF INVENTION

Recognizing the importance of the personal relationship between coach and coachee as a critical factor for coaching effectiveness, the invention facilitates a scalable, flexible, and measurable matching logic based on expertise, immediate business needs, and the requirements of the coachee's position, department, or industry. This relationship in turn establishes a sound basis for sustainable learning and behavioral change on the part of the coachee.

### BRIEF DESCRIPTION OF DRAWINGS

FIG. 1 shows an implementation of the matching logic in a serverless infrastructure.

FIG. 2 shows the coach properties used for the matching algorithm.

FIG. 3 shows a flowchart of the matching algorithm.

FIG. 4 shows the coach properties from which the ranking score is computed.

FIG. 5 shows the presentation of three coach profiles by means of a smartphone app.

### DESCRIPTION OF EMBODIMENTS

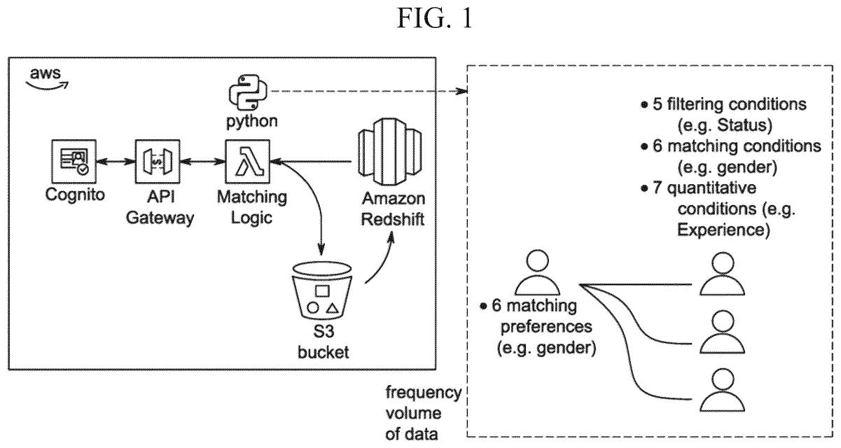

FIG. 1 illustrates an implementation of the matching logic compliant with a REST architectural style in a serverless infrastructure based on Amazon Web Services (AWS). In the present embodiment, the matching logic is deployed using the Amazon simple storage service (S3), executed by the Lambda (λ) computing platform that is provided as part of the AWS infrastructure. Accordingly, the logic is supplied with business intelligence (BI) from the Amazon Redshift data warehouse and exposed to front-end applications through the Amazon application programming interface (API) Gateway, allowing the coach or coachee to be authenticated by means of user and identity pools maintained in Amazon Cognito.

As any back-end developer will appreciate, corresponding embodiments, without departing from the scope of the invention, may employ Microsoft Azure, Google Cloud, or other suitable infrastructure as a service (IaaS) that meets the requirements of the platform with respect to frequency and volume of data.

In the example at hand, the matching logic is expressed in the well-established Python scripting language. Following said logic, the coachee is prompted to select six matching preferences with respect to the coach, such as a preferred mother tongue, age range, or gender. This coachee selection, along with further quantitative (e.g., experience) and filtering (e.g., status) conditions, defines the scope of the subsequent matching.

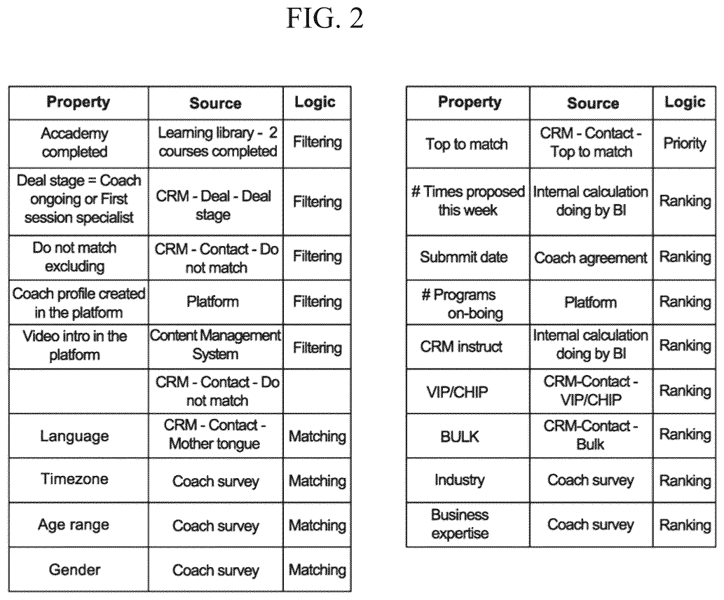

For this purpose, the platform, for each coach from its pool, establishes the properties depicted in FIG. 2. As is gathered from this compilation, the considered properties stem from various sources and affect the logic in multiple ways that will now be set forth in detail.

As an example, the matching system will only propose a coach if mandatory requirements are fulfilled. Static requirements of this type (qualified as “Filtering” in the “Logic” column) would include the creation of the coach's profile in the platform, completion of prerequisite on-boarding courses in a learning library (for example on data protection and confidentiality aspects), or recordal of a video introduction managed in a headless content management system. Other mandatory requirements (qualified as “Matching”) are imposed by the coachee's selection at runtime, the pertinent properties of the coach being sourced from a customer relationship management (CRM) suite or plainly specified by the coach herself in a survey.

Still further properties (qualified as “Priority” or “Ranking”) are optional yet used by the system to perform a ranking in cases where more than one coach fits the coachee. For instance, the frequency with which a coach, as per internal calculations by the BI source, has been proposed to other coachees—while not blocking or forcing a coach selection—could affect his or her rank among the fitting coaches.

As will become apparent from the figure, certain properties may influence the system in several respects. By way of example, the coach's prior agreement on certain terms such as willingness to reduce greenhouse emissions, as could be obtained in a custom web form, might be considered mandatory (“Filtering”), with other factors impacting the ranking as quantitative criteria.

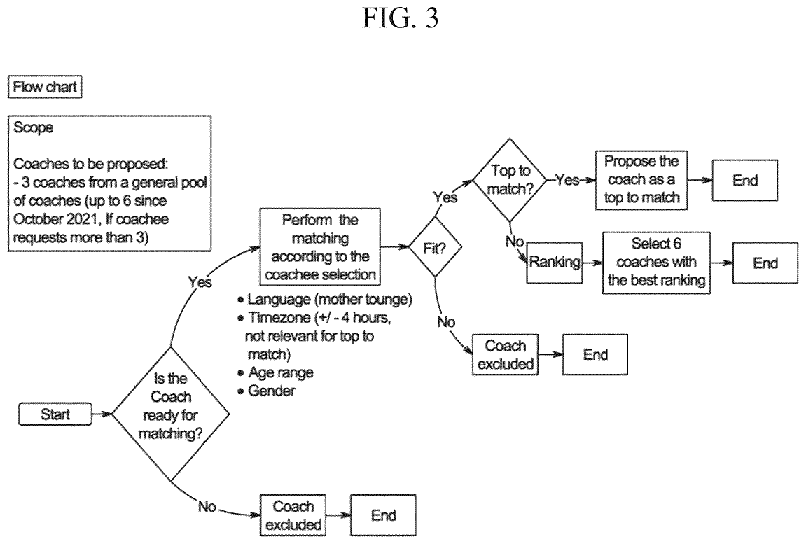

This system will now be elucidated in detail, referencing the flowchart of FIG. 3. As indicated to the left of the diagram, any coach whose properties violate the filtering conditions is excluded from the outset as not being ready for matching. Otherwise, as has been explained above by reference to FIG. 1, the matching is performed according to the coachee selection of preferences, identifying those coaches that fit the coachee in every regard.

It is noted that while in the present example of a regular coachee, matching is effected against the general pool of coaches, it may well be constrained to a predetermined sub-pool of coaches preselected in accordance with customer requirements. To improve workload balancing and mitigate any risk associated with independent contractors, the platform preferably restricts utilization of each coach to a maximum number of coachees serviced in parallel. Moreover, to avoid disguised employment and ensure regulatory compliance, assignments to any one coach may be capped depending on percentage of total income he or she receives from CoachHub. Finally, for ongoing quality assurance, individual coach performance is continuously evaluated and monitored in practice through session ratings and supervision by experienced senior coaches.

Where, according to his or her properties (cf. FIG. 2), a coach enjoys priority, that coach will receive a degree of advantage over other fitting candidates determined in the matching process. As described previously by reference to FIG. 2, the algorithm subjects the remaining coaches to a ranking based on their pertinent properties, selecting the highest-ranking coaches for proposal to the coachee.

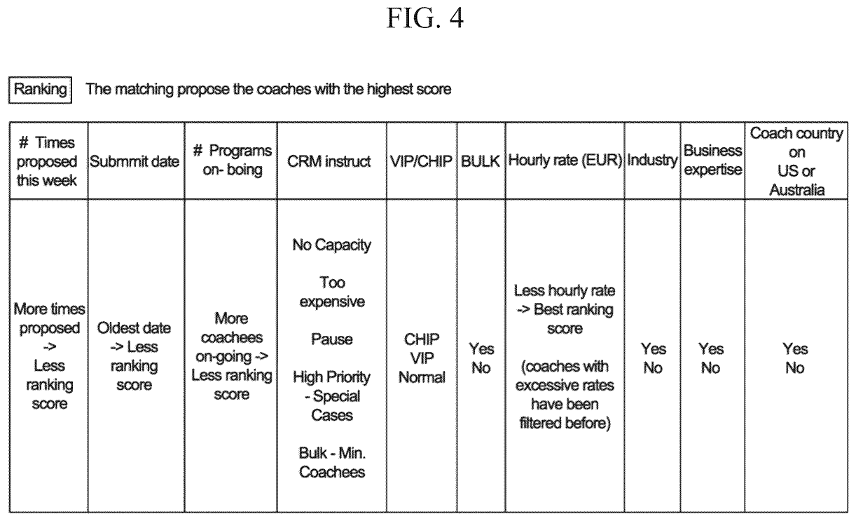

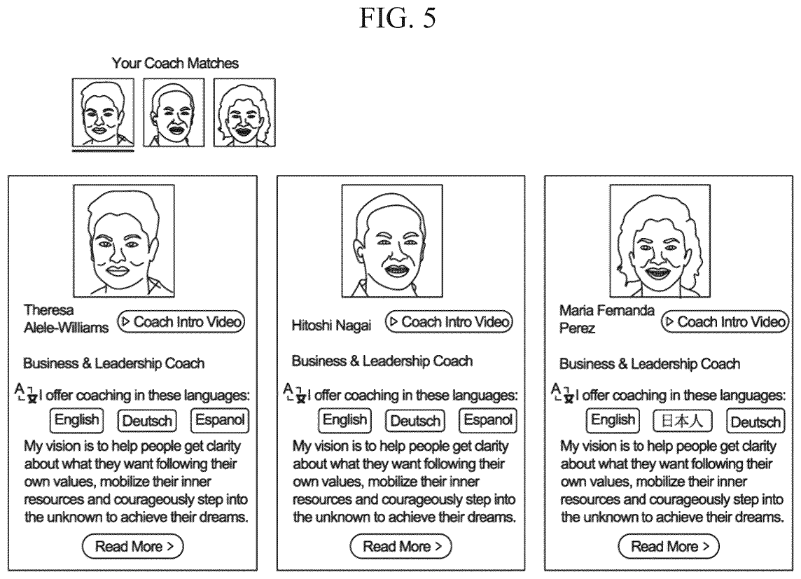

In the present embodiment, the ranking is based upon a score computed from the properties specified in FIG. 4, those coaches with the highest score ultimately being elected for the proposal. It is well understood that such proposal may be submitted to the coachee in various ways, such as through a Web or native application for the iOS or Android smartphone operating systems. The latter option is exemplified in FIG. 5, the proposal here taking the form of three coach profiles presented on the smartphone screen.

Even throughout this matching process, the platform may need to process various personal and sometimes confidential data such as names, titles and positions, contact information, employers, profile pictures, Internet Protocol (IP) addresses, credentials, or usage statistics. For coachees, additional data may include selected preferences, goals, focus areas, activities, billing data, et cetera. To reflect the importance of trust as a key driver for coaching success and simplify the regulatory environment for its corporate clients, the platform needs to support compliance with applicable law and in particular maintain the strictest levels of confidentiality, data protection, and information security for example by means of anonymization.

To this end, coachees' control and rights over personal data are enhanced through extensive and effective measures that meet the principles of data protection by design and by default. For instance, any personal data is encrypted during transit, may be anonymized or pseudonymized and administrators authenticate via a two factor process and important administrators generally by means of a cryptographic hardware security key as per the FIDO Client to Authenticator Protocol 2 (CTAP2). Moreover, the platform enforces role-based access control and data deletion, anonymization, and retention policies wherein digital coaching sessions are not stored except during their transmission, data processing protocols are deleted within a set number of days following the end of the processing, for example potentially necessary evidence for legal disputes may be retained for 4 years, and contracts stored for 7 years after the end of the contractual relationship. Where required, the transfer of personal data to third countries is avoided or performed in compliance with applicable data protection and other law.

### INDUSTRIAL APPLICABILITY

The invention is applicable, inter alia, throughout the adult education and expert matching industry.

### CITATION LIST

The following documents are cited hereinbefore.

### PATENT LITERATURE

PTL1: U.S. Pat. No. 9,679,495 B (BREAKTHROUGH PERFORMANCE TECH LLC [US]) Dec. 3, 2015

### NON-PATENT LITERATURE

NPL1: GRYGER, Liz, et al. Building Organizational Capabilities: Mckinsey Global Survey Results. Mckinsey Quarterly. 2010, no. 1, p. 288-295.

1. A computer-implemented method of proposing a coach to a coachee, the method comprising:
maintaining a pool of coaches, each coach possessing established properties,
confidentially prompting the coachee to make a selection of preferences with respect to the coach, and
based upon the properties, matching, according to the selection, the coachee with the coaches from the pool, and,
if one among the coaches fits the coachee, presenting a profile of the fitting coach using an application.

2. The method of claim 1, wherein the matching follows a logic expressed in a scripting language and is implemented in a serverless infrastructure.

3. The method of claim 2, wherein the logic is deployed using a storage service and executed by a computing platform of the infrastructure.

4. The method of claim 3, wherein the logic is exposed to the application through an application programming interface, and upon accessing the interface, the coach or coachee are authenticated.

5. The method of claim 4, wherein the properties are derived from at least one of the following sources:
the profile of the coach created in the platform,
completion of courses,
a prior agreement concluded with the coach in a custom web form,
a survey conducted among the coaches,
established customer relationships managed by a CRM suite,
content managed by a headless content management system,
business intelligence gathered from a data warehouse, operated within the infrastructure.

6. The method of claim 1, wherein conditions are placed for filtering the coaches unready for the matching such that coaches whose properties violate the conditions are excluded from the matching.

7. The method of claim 1, wherein, if multiple coaches fit the coachee, the fitting coaches are subjected to a ranking based upon the properties.

8. The method of claim 7, wherein, if, according to the properties, one among the fitting coaches enjoys priority, said coach is accorded top priority in the ranking.

9. The method of claim 7, wherein, if the ranking exceeds a predetermined number of fitting coaches, the corresponding number of highest-ranking coaches is selected.

10. The method of claim 9, wherein, upon request by the coachee, the number of coach proposals made is increased.

11. The method of claim 7, wherein, for each among the fitting coaches, a score is computed from the properties and the ranking is based upon the scores.

12. The method of claim 1, wherein, for specific clients, the matching is constrained by privacy, data protection, or confidentiality requirements.

13. The method of claim 1, wherein, for specific clients, the matching is constrained to ensure compliance with applicable laws relating to independent contractors.

14. The method of claim 1, wherein, for specific clients, the matching is constrained to a predetermined sub-pool of the coaches.

15. A data processing apparatus, comprising:
a means for carrying out the method of claim 1.

16. A computer program, comprising:
instructions which, when the program is executed by a computer, cause the computer to carry out the method of claim 1.

17. A data carrier signal carrying the computer program of claim 16.

18. The method as per claim 1, wherein the preferences are selected from the group consisting of a preferred mother tongue, age range, and gender of the coach.

19. The method as per claim 1, wherein the profile of the fitting coach is presented by a web or smartphone app.

20. The method as per claim 2, wherein the scripting language is Python and the serverless infrastructure is AWS.
